(19) United States
(12) Patent Application Publication
(10) Pub. No.: US 2010/0027871 A1
(43) Pub. Date: Feb. 4, 2010

(54) Method and system for inspection of tube width of heat exchanger

(75) Inventors: Akihiro Daito, Handa-city (JP); Kaoru Okazoe, Anjo-city (JP); Atsushi Fukumoto, Nishio-city (JP); Tomoaki Yoshimori, Okazaki-city (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/457,832

(22) Filed: Jun. 23, 2009

(30) Foreign Application Priority Data
Aug. 1, 2008 (JP) 2008-200024

(51) Int. Cl. G06K 9/00; G06F 19/00

(52) U.S. Cl. 382/141; 702/82

(57) ABSTRACT

An appearance inspection method and system of a core of a heat exchanger provided with fins and tubes including identifying a region in which an image of a single tube is captured, performing averaging and dynamic binarization of the image data in this region to extract only the image of the tube, dividing this region into a plurality of blocks, finding the smallest rectangle surrounding a tube at each divided block to find a width dimension of the tube, comparing the tube width dimension at each block found with a predetermined threshold value, and judging a part as good when all of the tube width dimensions at the blocks are the predetermined threshold value or less.

### BACKGROUND OF THE INVENTION

1. Field of the Invention

The present invention relates to an appearance inspection method and system of a heat exchanger, more particularly relates to an appearance inspection method and system of a fin-and-tube type heat exchanger used in automotive heaters and the like.

2. Description of the Related Art

FIG. 1 is a perspective view showing a fin-and-tube type heat exchanger 10 generally used in automotive heaters and the like. FIG. 2 is an enlarged view of the fin and tube parts wherein the heat exchanger 10 of FIG. 1 is rotated 90 degrees. The heat exchanger 10 is provided with a core 11 serving as a heat exchanger part. The core 11 is provided with a plurality of tubes 12 through which a fluid serving as a heat exchange medium passes and a large number of fins 13 that are attached to the surfaces of the tubes to increase the heat transfer area. Reference numerals 14 indicate tank parts and 15 side plates.

The core 11 of the fin-and-tube type heat exchanger 10 is formed by a plurality of unit elements, each provided with one straight tube 12 and a fin 13 attached in a bellows-like state on its surface, regularly repeated and connected. In such a unit element, the fin 13 is comprised of a flat sheet folded into an S-shape which is repeated to form a bellows shape. The fin 13 is therefore a folded part provided with a plurality of curved parts. Defects in the tubes 12 and fins 13 of such a heat exchanger can be detected by appearance inspection with a considerable success rate. Such appearance inspection has been improved for automation, labor-saving, and raising accuracy up to now. Recently, inspection methods making use of image processing have been introduced.

As such an inspection method using image processing, the inspection method such as shown in Japanese Unexamined Patent Publication (A) No. 2005-321300 is known.

This inspection method is an appearance inspection method of a core of a heat exchanger having a repeated pattern of the two components of a tube and fin. According to this inspection method, two images are captured in order to apply a fault detection method using image processing. One of the images of the part being inspected is an image captured as a tube inspection image while controlling the illumination so that the brightness of the image of the fin part is suppressed. The other inspection image is captured as a fin inspection image by an illumination by which the fin part can be inspected.

Further, a two-dimensional Fourier transform is applied to these tube or fin inspection images to obtain inspection images at the spatial frequency domains. Next, for example, parts of the input images are utilized to prepare mask image data for samples of good parts and this data is used to remove the frequency components of the good parts from the inspection images. Then, a two-dimensional inverse Fourier transform is further applied to obtain fault detection images.

However, when using the aforementioned prior art for inspecting tubes, the following problems have occurred. That is, in order to extract a tube, it was necessary to capture two inspection images at illuminations suitable for the tubes or the fins. When obtaining a tube inspection image, the image is captured while adjusting the level of the brightness until the fins are no longer visible, so differences in the surface conditions of a workpiece have become a cause of detection errors in inspection.

In tube inspection, transformed images of the inspection images obtained by application of a fast Fourier transform (FFT) and the transformed images of a normal tube part of the inspection image are used to find defects, so unless all of the tubes are at equal pitches, good precision detection is not possible. Further, by applying an FFT to the entire core, factors leading to detection errors will occur and the amount of data will end up becoming massive. In the case of FFT analysis, the transforms have to be applied twice, for regular and inverse, or else defects cannot be detected, thus causing the processing speed to drop. When performing inspection processing using FFT analysis, judgment based on the dimensional threshold value was difficult.

On the other hand, when inspection processing does not use FFT analysis, the object of inspection, that is, the core of the heat exchanger, is illuminated by an illumination device, and the imaging device captures images of the tubes and fins of the core part, converts the images to 256-tone image data, and this data is image processed to detect the skeleton of the tubes and inspect the tubes. The judgment criteria used in the inspection of the tubes are basically the tube length and tube width. Further, when measuring the width of the tubes, the following problems have occurred.

That is, in manufacturing the core of a heat exchanger, the tubes, fins, tanks, and side plates are assembled, then the assembly is secured by brazing it together by a furnace brazing step. At this time, due to the effects of heat distortion caused at the core in the furnace, the tubes bend at the two sides into a bow shape and, as a result, a so-called barrel-shape core is sometimes caused. FIG. 3 is a view schematically showing the fins and tubes of a core of a heat exchanger in the case where a barrel-shaped core has occurred. This barrel-shaped core is not a defect and should be judged as a good part.

However, when using the method of image processing such a barrel-shaped core to find the width of a tube as the width of the smallest rectangle surrounding the tube (method of surrounding the tube by a rectangle, shortening the sides of the rectangle until any point of the tube contacts the rectangle, and finding the sides of the rectangle at that time), there was the problem in that a tube bent into a bow shape became larger in width in comparison to a good part and a tube that should originally be deemed a good part ends up being judged as a defect.

FIG. 4A and FIG. 4B are views schematically showing a method of detecting a defect by finding a width of the smallest rectangle surrounding a tube. FIG. 4A shows a case of inspecting a normal, straight tube, while FIG. 4B shows a case of inspecting, in a similar manner, a tube bent into a bow shape.

### SUMMARY OF THE INVENTION

To solve the aforementioned problems, the invention of claim 1 is an appearance inspection method of a core of a heat exchanger provided with fins and tubes, the appearance inspection method of a core of a heat exchanger comprising a step of having an imaging device capture an image of the core and inputting into an image processing device the image data for storage, a step of identifying a region in the image data in which an image of a single tube is captured, a step of performing averaging and dynamic binarization of the image data in this region to extract only the image of the tube, a step of dividing this region into a plurality of blocks, a step of finding the smallest rectangle surrounding a tube at each divided block to find a width dimension of the tube, a step of comparing the tube width dimension at each block found with a predetermined threshold value, and a step of judging a part as good when all of the tube width dimensions at the blocks are the predetermined threshold value or less.

Due to this, it is possible to avoid ending up judging a tube bent into a bow shape, which should be deemed a good part, as a defect and possible to increase the processing speed.

The invention of claim 2 is the invention of claim 1 characterized in that the imaging device is a scanner.

The invention of claim 3 is the invention of claim 1 characterized in that the imaging device is provided with a CCD camera, a focusing/illumination device, and a belt conveyor.

Due to this, it is possible to automate and save labor in the inspection process and further to avoid ending up judging a tube bent into a bow shape, which should be deemed a good part, as a defect and possible to increase the processing speed.

The invention of claim 4 is an appearance inspection system of a core of a heat exchanger provided with fins and tubes, the appearance inspection system being provided with an imaging device and an image processing device, and the image processing device comprising a storage means for inputting and storing image data of the core captured by the imaging device, an image processing means for identifying a region in the image data in which the image of a single tube is captured, performing averaging and dynamic binarization on the image data in this region to extract only an image of a tube, and dividing the region into a plurality of blocks, a calculating means for finding, at each divided block, a width dimension of the tube by finding the smallest rectangle surrounding the tube, and a judging means for comparing the tube dimension width found at each block with a predetermined threshold value and judging a part is good when the tube width dimensions at the blocks are all the predetermined threshold value or less.

Due to this, in the same way as the invention of claim 1, it is possible to avoid ending up judging a tube bent into a bow shape, which should be deemed a good part, as a defect and possible to increase the processing speed.

### BRIEF DESCRIPTION OF THE DRAWINGS

These and other objects and features of the present invention will become clearer from the following description of the preferred embodiments given with reference to the attached drawings, wherein:

FIG. 1 is a perspective view showing a fin-and-tube type heat exchanger 10 generally used in an automotive heater and the like;

FIG. 2 is a view rotating the heat exchanger 10 of FIG. 1 by 90 degrees and showing the fin and tube part enlarged;

FIG. 3 is a view schematically showing the fins and tubes of the core of a heat exchanger in the event that a barrel-shaped core has been formed;

FIG. 4A is an explanatory view of a case when inspecting a normal straight tube;

FIG. 4B is an explanatory view of a case when inspecting a tube bent into a bow shape;

FIG. 5A is a schematic view of a tube width inspection system using a belt conveyor;

FIG. 5B is a schematic view of a tube width inspection system using a scanner;

FIG. 6 is a view dividing a tube displayed in a second window W into blocks; and

FIG. 7 is a view plotting a₁, a₂, a₃, a₄, and a₅ obtained by calculating widths of the divided segments of a tube at the blocks.

### DESCRIPTION OF THE PREFERRED EMBODIMENTS

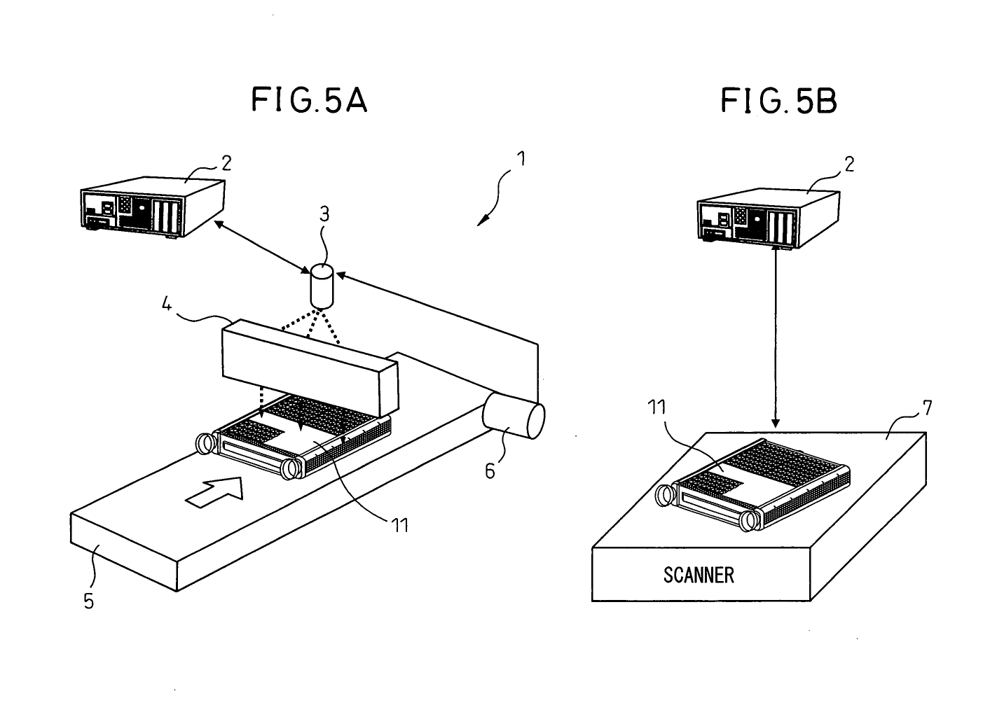

FIG. 5A, showing one embodiment of the present invention, is a schematic view of the hardware of a tube width inspection system using a belt conveyor, while FIG. 5B is a schematic view of the hardware of a tube width inspection system using a scanner 7.

Below, referring to FIG. 5A, one embodiment of the present invention concerning a tube width inspection system using a belt conveyor will be explained.

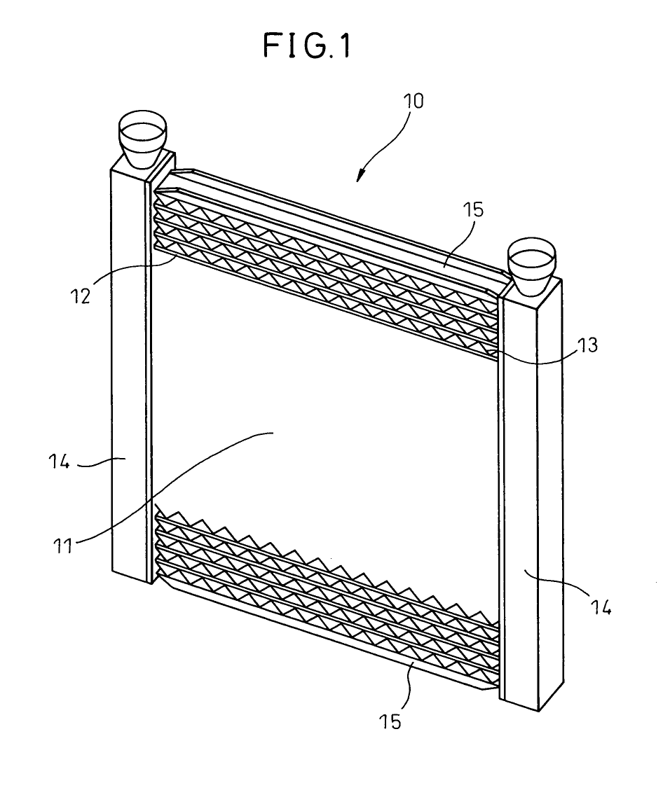

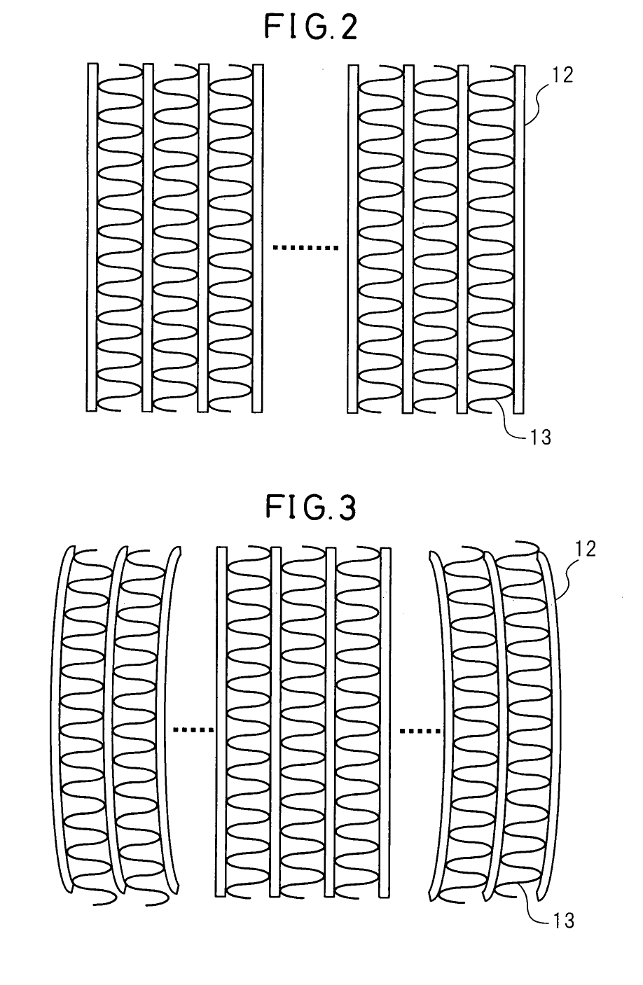

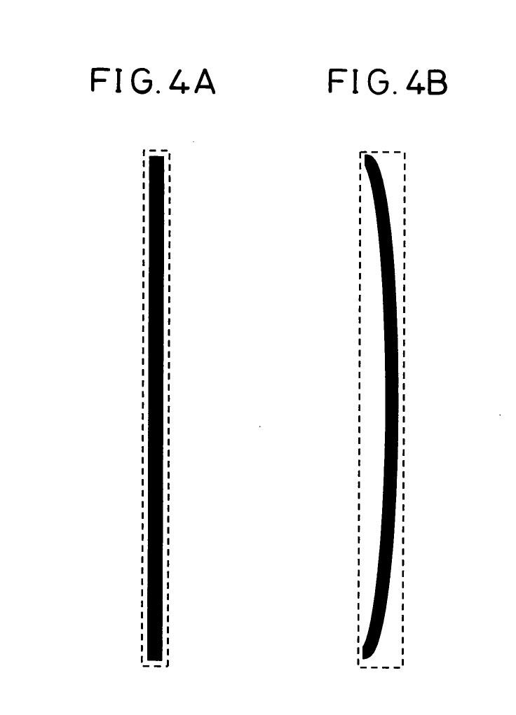

In the following embodiment, the object of inspection is the core 11 of a fin-and-tube type heat exchanger 10 used in automotive heaters and the like. Each component element of the fin-and-tube type heat exchanger being inspected is designated by the same notation as in FIG. 1.

The inspection system 1 shows an inspection system for inspecting a top surface of the core of the fin-and-tube type heat exchanger 10. In the inspection of the bottom surface of the core as well, an inspection system 1 having a similar configuration is used to perform inspection using a similar operation. The inspection system 1 is provided with an image processing device 2, a CCD camera or other imaging device 3, a focusing (lens)/illumination device 4, a belt conveyor 5, and an encoder 6 (not necessarily required) coupled to a drive unit of the belt conveyor.

In response to a signal from the encoder 6, the illumination device 4 illuminates the core 11 of the heat exchanger being inspected, and the imaging device 3 captures an image of the tubes and the fins of the core part and sends image data to the image processing device 2. The image processing device 2 converts this from an analog to digital format, then converts the image to 256 tone image data, and stores it as raw image data in a storage means.

In a tube width inspection system using a scanner 7 shown in FIG. 5B as well, the following processing is similar to that of the tube width inspection system using a belt conveyor of FIG. 5A.

A variety of possible means may be considered for selecting a single tube for judgment from the raw image data. To set the range of processing for the raw image data, first it is necessary to determine a reference point and set a first window with respect to the raw image data. In the first window, the reference point is determined while setting the long direction of the tube as the Y-axis. As the method of determining the reference point, as one example, it is possible to set the reference point by having the core 11 conveyed on a belt conveyor along a conveyor guide, having the imaging device 3 detect the tip of the core 11, and comparing this against already input product dimension data. Also, it is possible to set the reference point by processing the image and finding the overall external shape.

The center reference position for each tube can be found from the product dimension data or by image processing, so a single tube for judgment is selected from among these. Using the aforementioned center position as a reference, a rectangular second window W is set in a perpendicular direction (X-axis) to the long direction of the tube (Y-axis). The Y-axis direction of the second window W is also the long direction of the tube.

If averaging the tube, as one example, inside a rectangle having a horizontal width 3 times or more than the tube width and a size in the vertical direction of 1 pixel (when the tube width is 10 pixels), the tube will disappear and the fin image will remain. Next, if obtaining the difference between the fin image and the raw image, the fin will disappear and only the tube will remain. Further, noise is removed to obtain the tube image. The raw image data is processed by averaging and dynamic binarization in such a way to remove uneven background brightness.

In this second window W, the smallest rectangle surrounding the tube is found, and the X-axis distance width is calculated. This width is compared with the allowable value in which the tube is deemed to be nearly straight when seen from the product dimension data. When less than the allowable value, the next single tube is started. On the other hand, when the allowable value or more, the following processing for the case of a tube bent into a bow shape is started.

Various ways may be considered for setting the allowable value. As one example, the allowable value may be set by finding the average value of the widths of a plurality of tubes measured at regions comparatively free of bending in bow shapes in the core (for example the central area) and adding an empirically acquired constant value.

Next, the processing for the case where a tube is bent into a bow shape will be explained. This processing is the characterizing portion of the present invention.

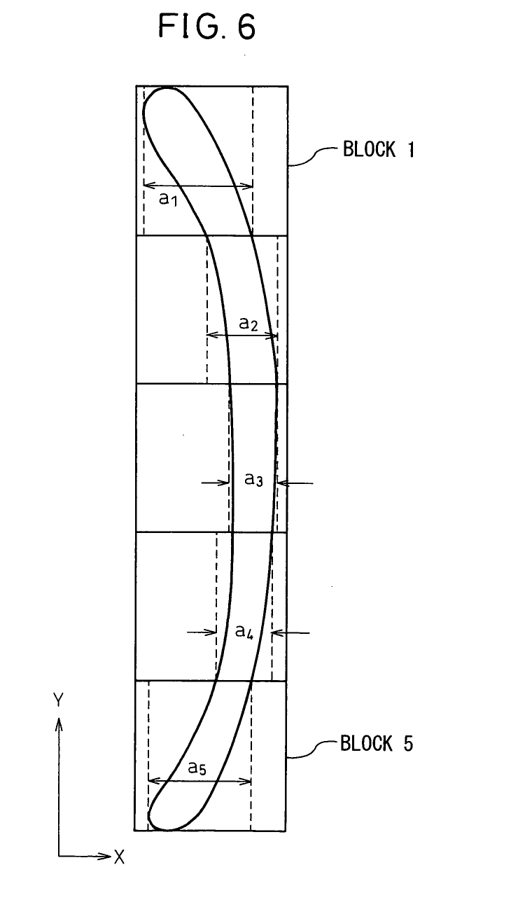

In the second window W, a single tube is extracted. The second window W is divided into a whole number n of blocks along the Y-axis direction. As explained above, the image processing means identifies the region in which the image of the single tube is captured, processes it by averaging and dynamic binarization to extracts the image of only the tube, and divides it into a plurality of blocks. FIG. 6 is a view in which the tube displayed in the second window W is divided into blocks.

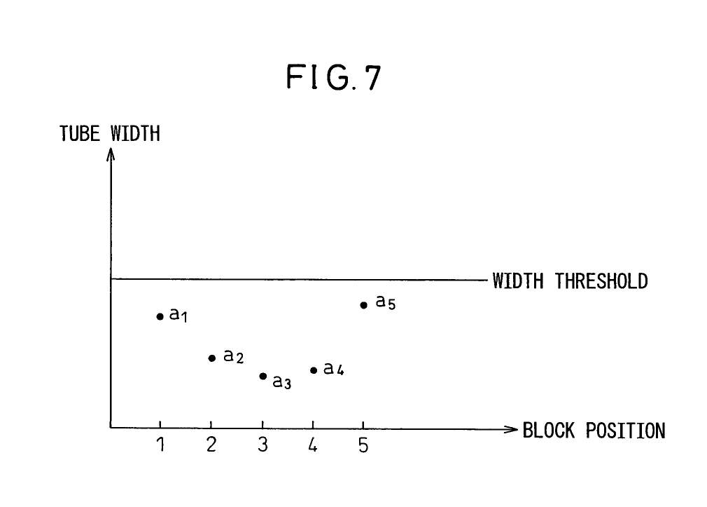

The calculating means finds the smallest rectangle for the divided segment of the tube at each block and calculates the width in the X-axis direction. In the case of FIG. 6, a₁, a₂, a₃, a₄, and a₅ are the values found. FIG. 7 is a view plotting the calculated a₁, a₂, a₃, a₄, and a₅. These are compared with a width threshold value A for judging a tube bent into a bow shape as a good part. When all are below it, the tube is judged to be a good part. If even one of the blocks exceeds the threshold value A, the tube is judged to be dented, deformed, having foreign matter deposited on it, or otherwise being a defect. By this judging means, the tube is judged as a good part or a defect.

Various ways may be considered for setting the threshold value. As one example, the threshold value may be set by finding the average value of the widths of a plurality of tubes measured at regions comparatively free of bending in bow shapes in the core (for example the central area) and adding an empirically acquired constant value. Alternatively, the threshold value may be found by accumulating the calculated a₁, a₂, a₃, a₄, a₅, etc. then statistically processing them.

In the aforementioned embodiment, in the second window, first, when the allowable value was exceeded, the tube was divided into blocks and the width of the segments were calculated. On the other hand, it is also possible to divide all of the tubes into blocks and calculate the widths of their segments. In this case, the calculation accuracy of the tube can be increased.

As explained above, according to the present invention, it is possible to avoid judging a tube bent into a bow shape which should be judged as a good part as being defective.

While the invention has been described with reference to specific embodiments chosen for purpose of illustration, it should be apparent that numerous modifications could be made thereto by those skilled in the art without departing from the basic concept and scope of the invention.

1. An appearance inspection method of a core of a heat exchanger provided with fins and tubes,
the appearance inspection method of a core of a heat exchanger comprising
a step of having an imaging device capture an image of the core and inputting into an image processing device the image data for storage,
a step of identifying a region in the image data in which an image of a single tube is captured,
a step of performing averaging and dynamic binarization of the image data in this region to extract only the image of the tube,
a step of dividing this region into a plurality of blocks,
a step of finding the smallest rectangle surrounding a tube at each divided block to find a width dimension of the tube,
a step of comparing the tube width dimension at each block found, with a predetermined threshold value, and
a step of judging a part as good when all of the tube width dimensions at the blocks are the predetermined threshold value or less.

2. An appearance inspection method of a core of a heat exchanger as set forth in claim 1, wherein the imaging device is a scanner.

3. An appearance inspection method of a core of a heat exchanger as set forth in claim 1, wherein the imaging device is provided with a CCD camera, a focusing/illumination device, and a belt conveyor.

4. An appearance inspection system of a core of a heat exchanger provided with fins and tubes,
the appearance inspection system being provided with an imaging device and an image processing device, and
the image processing device comprising
a storage means for inputting and storing image data of the core captured by the imaging device,
an image processing means for identifying a region in the image data in which the image of a single tube is captured, performing averaging and dynamic binarization on the image data in this region to extract only an image of a tube, and dividing the region into a plurality of blocks,
a calculating means for finding, at each divided block, a width dimension of the tube by finding the smallest rectangle surrounding the tube, and
a judging means for comparing the tube dimension width found at each block with a predetermined threshold value and judging a part is good when the tube width dimensions at the blocks are all the predetermined threshold value or less.
